(19) United States
(12) Patent Application Publication
(10) Pub. No.: US 2025/0122231 A1
(43) Pub. Date: Apr. 17, 2025

(54) COMPOUND, COATING COMPOSITION CONTAINING SAME, METHOD FOR PREPARING COMPOUND, AND ELECTRONIC DEVICE

(71) Applicant: LG CHEM, LTD., Seoul (KR)

(72) Inventors: Jihye JUNG, Daejeon (KR); Beomsu PARK, Daejeon (KR); Hyun Cheol KIM, Daejeon (KR)

(73) Assignee: LG CHEM, LTD., Seoul (KR)

(21) Appl. No.: 18/568,185

(22) PCT Filed: Mar. 21, 2023
(86) PCT No.: PCT/KR2023/003717

§ 371 Date: Dec. 7, 2023

(30) Foreign Application Priority Data
Mar. 25, 2022 (KR) 10-2022-0037305

(51) Int. Cl. C07F 7/18; C09D 183/06

(52) U.S. Cl. CPC C07F 7/1896; C09D 183/06

(57) ABSTRACT

The present specification relates to a compound of Chemical Formula 1, a coating composition including the same, a method for preparing the compound, and an electronic device.

### CROSS-REFERENCE TO RELATED APPLICATIONS

This application is a 35 U.S.C. § 371 National Phase Entry Application from PCT/KR2023/003717, filed on Mar. 21, 2023, which claims priority to and the benefit of Korean Patent Application No. 10-2022-0037305 filed in the Korean Intellectual Property Office on Mar. 25, 2022, the entire contents of which are incorporated herein by reference.

### TECHNICAL FIELD

The present specification relates to a compound, a coating composition including the same, a method for preparing a compound, and an electronic device.

### BACKGROUND

Compounds containing a perfluoroalkyl group have been widely used in the field of surface coating agents because the compounds reduce surface lifting and dielectric constant in the film due to low surface energy to lower the dielectric constant of the entire composition, and have high heat resistance. In the related art, although the compounds have been derived through nucleophilic substitution using a Grignard reagent and a halogenated compound or derivatives thereof in order to introduce a perfluoroalkyl group into the compounds, there are disadvantages in that the reaction is complex, toxic gases such as chloride gases may be produced, and the reaction is sensitive to air and moisture. Since silane-based compounds may be used as coating compositions which enhance durability by forming strong physico-chemical bonds on the surface of glass or metal, it is possible to form a coating film capable of imparting low dielectric properties on the surface while enhancing adhesion ability when a perfluoroalkyl group is introduced into the silane-based compounds. However, it is not advantageous in terms of compatibility to directly introduce a perfluoroalkyl group into a composition.

### BRIEF SUMMARY

### Technical Problem

The present specification provides a compound, a coating composition including the same, a method for preparing the compound, and an electronic device.

### Technical Solution

An exemplary embodiment of the present specification provides a compound of the following Chemical Formula 1.

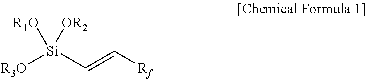

In Chemical Formula 1,
R₁ to R₃ are each independently an alkyl group,
R_{f} is CₙF₂ₙ₊₁, and n is an integer from 1 to 20.

Another exemplary embodiment of the present specification provides a coating composition including the compound.

Still another exemplary embodiment of the present specification provides a method for preparing the compound, the method including: synthesizing an alkoxy silane intermediate by mixing an alkoxy silane compound and a perfluoroalkyl compound; and introducing a double bond into the alkoxy silane intermediate through an elimination reaction.

Yet another exemplary embodiment of the present specification provides an electronic device including the compound or a cured product thereof.

### Advantageous Effects

A compound according to an exemplary embodiment of the present specification can be easily used as a polymer monomer by including all of a perfluoroalkyl group, a silane group and a vinyl group. Further, a polymer having desired properties can be synthesized by directly participating in cross-linking with other curable compositions during polymer synthesis.

The compound according to an exemplary embodiment of the present specification, when used as a polymer monomer, does not require reaction conditions such as high heat and high pressure, compounds and addition reactants participating in the reaction are easily removed, and high-purity materials can be easily obtained.

A coating composition including the compound according to an exemplary embodiment of the present specification has a low dielectric constant, high heat resistance and durability, and excellent adhesive force.

### DETAILED DESCRIPTION

Hereinafter, the present specification will be described in more detail.

An exemplary embodiment of the present specification provides a compound of the following Chemical Formula 1.

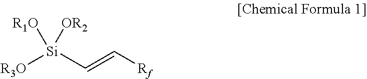

In Chemical Formula 1,
R₁ to R₃ are each independently an alkyl group,
R_{f} is CₙF₂ₙ₊₁, and n is an integer from 1 to 20.

In an exemplary embodiment of the present specification, R₁ to R₃ are each independently an alkyl group having 1 to 30 carbon atoms.

In an exemplary embodiment of the present specification, R₁ to R₃ are each independently an alkyl group having 1 to 20 carbon atoms.

In an exemplary embodiment of the present specification, R₁ to R₃ are each independently an alkyl group having 1 to 10 carbon atoms.

In an exemplary embodiment of the present specification, R₁ to R₃ are each independently an alkyl group having 1 to 5 carbon atoms.

In an exemplary embodiment of the present specification, R₁ to R₃ may be each independently a methyl group; an ethyl group; a propyl group; a butyl group; or a pentyl group.

In an exemplary embodiment of the present specification, R₁ to R₃ may be each independently a methyl group; an ethyl group; or a propyl group.

In an exemplary embodiment of the present specification, R₁ to R₃ may be each independently a methyl group; or an ethyl group.

In an exemplary embodiment of the present specification, R₁ to R₃ may be each independently a methyl group.

In an exemplary embodiment of the present specification, R₁ to R₃ may be each independently an ethyl group.

In an exemplary embodiment of the present specification, n is an integer from 1 to 20.

According to an exemplary embodiment of the present specification, when n is within the above range, compounds with various molecular weights may be prepared because the chain length of a perfluoroalkyl group is easily adjusted.

Although a compound including a perfluoroalkyl group exhibits the characteristics of a low dielectric constant and high heat resistance, there is a problem in that it difficult to prepare the compound in terms of compatibility. However, the compound of Chemical Formula 1 can be easily used as a polymer monomer by including all of a perfluoroalkyl group, a silane group and a vinyl group, and a desired polymer can be synthesized by directly participating in cross-linking with other curable compositions.

In an exemplary embodiment of the present specification, n may be an integer from 3 to 20, an integer from 3 to 15, an integer from 3 to 12, or an integer from 3 to 11.

In an exemplary embodiment of the present specification, n may be an integer from 4 to 20, an integer from 4 to 15, an integer from 4 to 12, an integer from 4 to 11, or an integer from 4 to 8.

In an exemplary embodiment of the present specification, hydrogen is linked to the portions in which a substituent is not indicated in the double bond of Chemical Formula 1.

According to an exemplary embodiment of the present specification, Chemical Formula 1 may be any one selected from the following compounds.

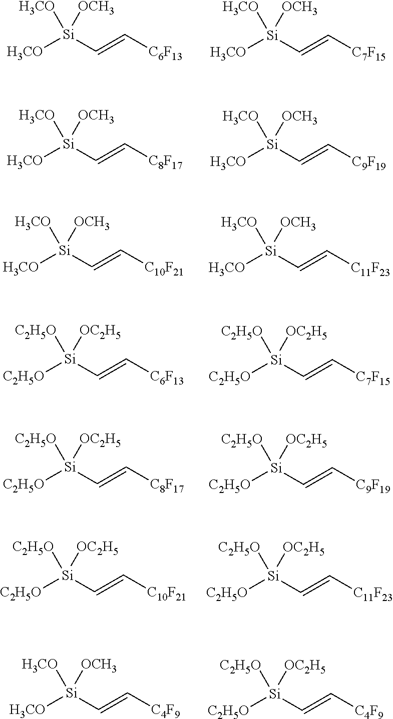

According to an exemplary embodiment of the present specification, Chemical Formula 1 includes a mixture of the compounds of Chemical Formula 1.

Specifically, the mixture of the compounds of Chemical Formula 1 means that two or more of the compounds of Chemical Formula 1 are included, and the structures thereof may be the same as or different from each other.

In an exemplary embodiment of the present specification, the compound may have a refractive index of 1.4 or less, and the lower limit thereof is not limited, but is, for example, 1.2 or more.

In an exemplary embodiment of the present specification, the compound may have a refractive index of 1.3 or less.

When a compound having a refractive index within the above range is included in a coating composition, there is an effect of lowering the refractive index and dielectric constant of the coating composition and enhancing heat resistance and durability.

In an exemplary embodiment of the present specification, the refractive index of the compound is measured at 25° C. using an RX-5000a (manufactured by ATAGO).

An exemplary embodiment of the present specification provides a coating composition including the compound.

A coating composition according to an exemplary embodiment of the present specification has low refractive index and low dielectric constant, and high heat resistance and high durability. In addition, the coating composition according to an exemplary embodiment of the present specification is used as an adhesive coating agent by providing excellent adhesive force.

In an exemplary embodiment of the present specification, the coating composition may further include one or more curable compounds.

In an exemplary embodiment of the present specification, the above-described compound may be cross-linked with the curable compound to form a polymer.

Since the compound according to an exemplary embodiment of the present invention includes a double bond, the compound can directly participate in cross-linking with the curable compound, and thus does not require reaction conditions such as high heat and high pressure. Furthermore, compounds and addition reactants participating in cross-linking can be easily removed, and a high-purity polymer can be obtained.

In an exemplary embodiment of the present specification, the curable compound is not limited as long as it includes a vinyl group, that is, a double bond.

In an exemplary embodiment of the present specification, the coating composition may have a refractive index of 1.5 or less.

In an exemplary embodiment of the present specification, the coating composition may have a refractive index of 1.5 or less, or 1.4 or less, and the lower limit thereof is not limited, but may be 1.1 or more.

In an exemplary embodiment of the present specification, the refractive index of the coating composition is measured at 25° C. using an RX-5000a (manufactured by ATAGO).

A coating composition having the above refractive index range has a low dielectric constant, and thus, can be used as a material capable of implementing the ultra-high efficiency of data transmission used in electronic materials.

An exemplary embodiment of the present specification provides a method for preparing the compound, the method including: synthesizing an alkoxy silane intermediate by mixing an alkoxy silane compound and a perfluoroalkyl compound; and introducing a double bond into the alkoxy silane intermediate through an elimination reaction.

In an exemplary embodiment of the present specification, the alkoxy silane compound may be represented by the following Chemical Formula 2.

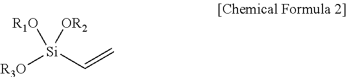

In Chemical Formula 2,

R₁ to R₃ are each independently an alkyl group.

The specific description on R₁ to R₃ of Chemical Formula 2 is the same as the above-described description of Chemical Formula 1.

In an exemplary embodiment of the present specification, the perfluoroalkyl compound may be represented by the following Chemical Formula 3.

X—R_{f} [Chemical Formula 3]

In Chemical Formula 3,
X is a halogen group,
R_{f} is CₙF₂ₙ₊₁, and n is an integer from 1 to 20.

In the present specification, the halogen group means a Group 17 element of the periodic table, and specifically, may be —F, —Br, —Cl or —I.

In an exemplary embodiment of the present specification, X may be —I.

In an exemplary embodiment of the present specification, the alkoxy silane intermediate may be represented by the following Chemical Formula 4.

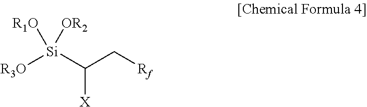

In Chemical Formula 4,
R₁ to R₃ are each independently an alkyl group,
X is a halogen group,
R_{f} is CₙF₂ₙ₊₁, and n is an integer from 1 to 20.

In an exemplary embodiment of the present specification, in the synthesizing of the alkoxy silane intermediate, the reaction temperature is 10° C. to 40° C., preferably 20° C. to 40° C., and more preferably 30° C.

When synthesis is performed within the above reaction temperature range, the reaction conditions are not tricky, but mild, and side reactions that appear as the temperature rises are suppressed, so that the yield of a final object is increased.

In an exemplary embodiment of the present specification, in the synthesizing of the alkoxy silane intermediate, the reaction pressure is normal pressure.

In an exemplary embodiment of the present specification, in the synthesizing of the alkoxy silane intermediate, a radical chain reaction may be used.

In an exemplary embodiment of the present specification, a radical initiator and a solvent may be used in the radical chain reaction.

In an exemplary embodiment of the present specification, the radical initiator is an azo initiator.

In an exemplary embodiment of the present specification, the radical initiator is any one or more selected among azobisisobutyronitrile (AIBN), 2,2′-azobis-(2,4-dimethylvaleronitrile), 2,2′-azobis(4-methoxy-2,4-dimethylvaleronitrile), benzoyl peroxide (BPO) or di-tert-butyl peroxide (DTBP).

Preferably, the radical initiator may be azobisisobutyronitrile (AIBN).

When the radical initiator is used, the radical reaction can be initiated at a low temperature, so that there is an advantage in that the reaction can be performed at the reaction temperature and under mild reaction conditions.

In an exemplary embodiment of the present specification, the solvent is an organic solvent.

In an exemplary embodiment of the present specification, the solvent is selected among hexane, heptane, toluene, benzene, dichloromethane, dichloroethane, trichloroethane, chloroform, dichloroform, nitromethane, dibromomethane, cyclopentanone, cyclohexanone, fluorobenzene, bromobenzene, chlorobenzene, xylene, mesitylene, ethylacetate or any mixture thereof, but is not limited thereto, and an organic solvent used in the related art may be used.

In an exemplary embodiment of the present specification, the solvent may be ethyl acetate.

In an exemplary embodiment of the present specification, in the introducing of the double bond into the alkoxy silane intermediate, the reaction temperature is room temperature, and may be, for example, 10° C. to 30° C.

In an exemplary embodiment of the present specification, in the introducing of the double bond into the alkoxy silane intermediate, the reaction pressure is normal pressure.

In an exemplary embodiment of the present specification, in the introducing of the double bond into the alkoxy silane intermediate, an elimination reaction is used.

In an exemplary embodiment of the present specification, a base and a solvent may be used in the elimination reaction.

In an exemplary embodiment of the present specification, examples of the base include 1,8-diazabicyclo [5.4.0]undec-7-ene (DBU), trimethylamine, sodium hydroxide, and the like, but are not limited thereto.

Preferably, the base may be 1,8-diazabicyclo [5.4.0]undec-7-ene (DBU).

In an exemplary embodiment of the present specification, the solvent used in the elimination reaction is the same as the description of the solvent in the synthesizing of the alkoxy silane intermediate.

In an exemplary embodiment of the present specification, the introducing of the double bond into the alkoxy silane intermediate may further include: separating a supernatant and a subnatant in addition to the elimination reaction; and removing a by-product from the supernatant.

In an exemplary embodiment of the present specification, when the elimination reaction is completed, the liquid is separated into a supernatant and a subnatant. The time point at which the liquid is separated into the supernatant and the subnatant is not limited to the time point after the completion of the elimination reaction, and layer separation may occur while the elimination reaction proceeds.

In an exemplary embodiment of the present specification, in the separating of the supernatant and the subnatant, separation methods generally used in the art may be used.

In an exemplary embodiment of the present specification, a final object compound and a by-product may be included in the supernatant.

In an exemplary embodiment of the present specification, a base and a by-product may be included in the subnatant. The base included in the subnatant is the same as the description of the above-described base as an unreacted base which does not participate in the reaction.

In an exemplary embodiment of the present specification, the by-product may be HF, HCl, HBr, or HI.

In an exemplary embodiment of the present specification, the removing of the by-product from the supernatant may include: precipitating the by-product; and filtering the precipitated by-product.

In an exemplary embodiment of the present specification, in the precipitating of the by-product, a hexane, a heptane, an ether, and the like may be used, but are not limited thereto.

In an exemplary embodiment of the present specification, in the filtering of the precipitated by-product, filtration methods generally used in the art may be used.

According to an exemplary embodiment of the present specification, provided is a mixture including two or more of the compounds.

According to another exemplary embodiment of the present specification, two or more compounds included in the mixture are the same as or different from each other. That is, it means that the two or more compounds are the same as or different from each other while having the structure of Chemical Formula 1.

According to still another exemplary embodiment of the present specification, the mixture may further include a compound different from the compound of Chemical Formula 1.

According to an exemplary embodiment of the present specification, provided is a single molecule derived from the compound of Chemical Formula 1.

In this specification, for example, the above-mentioned “single molecule derived from the compound of Chemical Formula 1” may mean a single molecule in which the vinyl group of the compound of Chemical Formula 1 forms a radical and an additional substituent is introduced, or the compound of Chemical Formula 1 itself.

According to an exemplary embodiment of the present specification, provided is a polymer including a monomer derived from the compound of Chemical Formula 1.

Those skilled in the art will understand the term “monomer” described in the present specification as a state in which a compound is polymerized to be linked to the main chain of the polymer.

In the present specification, for example, the “monomer derived from the compound of Chemical Formula 1” is a repeating unit that constitutes the main chain in the polymer, and means that a vinyl group of the compound of Chemical Formula 1 may form a radical to become a monomer, and a monomer or end group which makes up the main chain of other polymers may be introduced.

According to an exemplary embodiment of the present specification, the polymer may further include an additional monomer, and the additional monomer is not limited.

According to an exemplary embodiment of the present specification, the additional monomer may be a monomer derived from the above-described curable compound.

According to an exemplary embodiment of the present specification, the polymer may be an alternating polymer, a block polymer, or a random polymer, but is not limited thereto.

Further, in the present specification, even when a monomer included in the polymer is mentioned, the monomer is not limited to including only the mentioned monomer, and other monomers in addition to the aforementioned monomer may additionally be included as co-monomers within a range not departing from the object of the present invention.

A compound and a composition according to an exemplary embodiment of the present specification, and a single molecule and a polymer derived from the compound are used as an electronic material, an organic insulating material, a substrate material and/or a semiconductor material, but are not limited thereto.

An exemplary embodiment of the present specification provides an electronic device including the compound or a cured product thereof.

An exemplary embodiment of the present specification provides an electronic device including a coating composition including the compound.

According to an exemplary embodiment of the present specification, provided is an electronic device including a coating composition including the compound and the curable compound.

Hereinafter, the present specification will be described in detail with reference to Examples for specifically describing the present specification. However, the Examples according to the present specification may be modified in various forms, and it is not interpreted that the scope of the present specification is limited to the Examples described below in detail. The Examples of the present specification are provided to explain the present specification more completely to a person with ordinary skill in the art.

### <Preparation Examples> Preparation of Compound

### <Example 1> Compound 1

After 46 g of vinyltrimethoxy silane and 53 mL of nonafluoro-1-iodobutane were dissolved in 15 g of ethyl acetate in a 200-mL 2 neck round-bottom flask, the resulting solution was bubbled with nitrogen at 30° C. for 30 minutes. After 1.5 g of azobisisobutyronitrile (AIBN) was added thereto, trimethoxy (3,3,4,4,5,5,6,6,6-nonafluoro-1-iodooctyl) silane was synthesized by stirring the resulting mixture for 3 hours. Thereafter, 100 mL of ethyl acetate was added thereto, and 42 mL of 1,8-diazabicyclo [5.4.0]undec-7-ene (DBU) was slowly added dropwise thereto to perform an elimination reaction. After the completion of the reaction, the DBU and HI salt layers, which were the subnatant, were removed when separation occurred between the reaction solutions. Residual by-products remaining in the supernatant were removed by precipitation with hexane to obtain the following Compound 1.

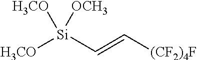

As a result of confirming the ¹H-NMR of Compound 1, the ¹H-NMR chart is as follows.

¹H-NMR (500 MHz, CDCl₃, ppm TMS) δ: 3.59 (9H, S), 6.39 (2H, m)

The MS measurement results of Compound 1 are as follows, and were measured after a CH₃— (methyl) group was eliminated during the GC/EI ionization process.

Ionization mode=: APCI+: m/z=351.0 [M+H]+, Exact Mass: 366.0

### <Example 2> Compound 2

After 46 g of vinyltrimethoxy silane and 67 mL of tridecafluorohexyl iodide were dissolved in 15 g of ethyl acetate in a 200-mL 2 neck round-bottom flask, the resulting solution was bubbled with nitrogen at 30° C. for 30 minutes. After 1.5 g of azobisisobutyronitrile (AIBN) was added thereto, trimethoxy (3,3,4,4,5,5,6,6,7,7,8,8,8-tridecafluoro-1-iodooctyl) silane was synthesized by stirring the resulting mixture was for 3 hours. Thereafter, 100 mL of ethyl acetate was added thereto, and 42 mL of 1,8-diazabicyclo [5.4.0]undec-7-ene (DBU) was slowly added dropwise thereto to perform an elimination reaction. After the completion of the reaction, the DBU and HI salt layers, which were the subnatant, were removed when separation occurred between the reaction solutions. Residual by-products remaining in the supernatant were removed by precipitation with hexane to obtain the following Compound 2.

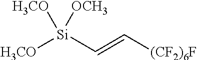

As a result of confirming the ¹H-NMR of Compound 2, the ¹H-NMR chart is as follows.

¹H-NMR (500 MHZ, CDCl₃, ppm TMS) δ: 3.61 (9H, S), 6.39 (2H, m)

The GC-MS measurement results of Compound 2 are as follows, and were measured after a CH₃-(methyl) group was eliminated during the GC/EI ionization process.

Ionization mode=: APCI+: m/z=451.0 [M+H]+, Exact Mass: 466.0

### <Example 3> Compound 3

After 46 g of vinyltrimethoxy silane and 82 mL of heptadecafluoro-1-iodobutane were dissolved in 15 g of ethyl acetate in a 200-mL 2 neck round-bottom flask, the resulting solution was bubbled with nitrogen at 30° C. for 30 minutes. After 1.5 g of azobisisobutyronitrile (AIBN) was added thereto, trimethoxy (3,3,4,4,5,5,6,6,7,7,8,8,9,9,10,10,10-heptadecafluoro-1-iodooctyl) silane was synthesized by stirring the resulting mixture for 3 hours. Thereafter, 100 mL of ethyl acetate was added thereto, and 42 mL of 1,8-diazabicyclo [5.4.0]undec-7-ene (DBU) was slowly added dropwise thereto to perform an elimination reaction. After the completion of the reaction, the DBU and HI salt layers, which were the subnatant, were removed when separation occurred between the reaction solutions. Residual by-products remaining in the supernatant were removed by precipitation with hexane to obtain the following Compound 3.

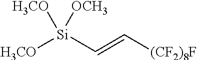

As a result of confirming the ¹H-NMR of Compound 3, the ¹H-NMR chart is as follows.

¹H-NMR (500 MHZ, CDCl₃, ppm TMS) δ: 3.60 (9H, S), 6.40 (2H, m)

The MS measurement results of Compound 3 are as follows, and were measured after a CH₃-(methyl) group was eliminated during the GC/EI ionization process.

Ionization mode=: APCI+: m/z=551.0 [M+H]+, Exact Mass: 566.0

### <Example 4> Compound 4

After 59 g of vinyltriethoxy silane and 53 mL of nonafluoro-1-iodobutane were dissolved in 15 g of ethyl acetate in a 200-mL 2 neck round-bottom flask, the resulting solution was bubbled with nitrogen at 30° C. for 30 minutes. After 1.5 g of azobisisobutyronitrile (AIBN) was added thereto, triethoxy (3,3,4,4,5,5,6,6,6-nonafluoro-1-iodobutyl) silane was synthesized by stirring the resulting mixture for 3 hours. Thereafter, 100 mL of ethyl acetate was added thereto, and 42 mL of 1,8-diazabicyclo [5.4.0]undec-7-ene (DBU) was slowly added dropwise thereto to perform an elimination reaction. After the completion of the reaction, the DBU and HI salt layers, which were the subnatant, were removed when separation occurred between the reaction solutions. Residual by-products remaining in the supernatant were removed by precipitation with hexane to obtain the following Compound 4.

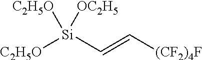

As a result of confirming the ¹H-NMR of Compound 4, the ¹H-NMR chart is as follows.

¹H-NMR (500 MHZ, CDCl₃, ppm TMS) δ: 1.24 (9H, m), 3.84 (6H, m), 6.41 (2H, m)

### <Example 5> Compound 5

After 59 g of vinyltriethoxy silane and 67 mL of tridecafluorohexyl iodide were dissolved in 15 g of ethyl acetate in a 200-mL 2 neck round-bottom flask, the resulting solution was bubbled with nitrogen at 30° C. for 30 minutes. After 1.5 g of azobisisobutyronitrile (AIBN) was added thereto, triethoxy (3,3,4,4,5,5,6,6,7,7,8,8,8-tridecafluoro-1-iodohexyl) silane was synthesized by stirring the resulting mixture for 3 hours. Thereafter, 100 mL of ethyl acetate was added thereto, and 42 mL of 1,8-diazabicyclo [5.4.0]undec-7-ene (DBU) was slowly added dropwise thereto to perform an elimination reaction. After the completion of the reaction, the DBU and HI salt layers, which were the subnatant, were removed when separation occurred between the reaction solutions. Residual by-products remaining in the supernatant were removed by precipitation with hexane to obtain the following Compound 5.

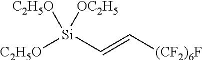

As a result of confirming the ¹H-NMR of Compound 5, the ¹H-NMR chart is as follows.

¹H-NMR (500 MHZ, CDCl₃, ppm TMS) δ: 1.24 (9H, m), 3.85 (6H, m), 6.41 (2H, m)

### <Example 6> Compound 6

After 59 g of vinyltriethoxy silane and 82 mL of heptadecafluoro-n-octyliodide were dissolved in 15 g of ethyl acetate in a 200-mL 2 neck round-bottom flask, the resulting solution was bubbled with nitrogen at 30° C. for 30 minutes. After 1.5 g of azobisisobutyronitrile (AIBN) was added thereto, triethoxy (3,3,4,4,5,5,6,6,7,7,8,8,9,9,10,10,10-heptadecafluoro-1-iodooctyl) silane was synthesized by stirring the resulting mixture for 3 hours. Thereafter, 100 mL of ethyl acetate was added thereto, and 42 mL of 1,8-diazabicyclo [5.4.0]undec-7-ene (DBU) was slowly added dropwise thereto to perform an elimination reaction. After the completion of the reaction, the DBU and HI salt layers, which were the subnatant, were removed when separation occurred between the reaction solutions. Residual by-products remaining in the supernatant were removed by precipitation with hexane to obtain the following Compound 6.

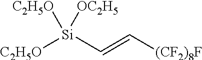

As a result of confirming the ¹H-NMR of Compound 6, the ¹H-NMR chart is as follows.

δ: 1.24 (9H, m), 3.85 (6H, m), 6.41 (2H, m)

### <Experimental Example> Measurement of Refractive Index

The refractive indices of the compounds prepared in the Examples and the comparative example compounds shown in the following Table 1 were measured at 25° C. using an RX-5000a (manufactured by ATAGO).

TABLE 1

| | Compound | Refractive index |
|---|---|---|
| Example 1 | Compound 1 | 1.372 |
| Example 2 | Compound 2 | 1.341 |
| Example 3 | Compound 3 | 1.298 |
| Example 4 | Compound 4 | 1.387 |
| Example 5 | Compound 5 | 1.375 |
| Example 6 | Compound 6 | 1.351 |
| Comparative Example 1 | Vinyltrimethoxy silane | 1.391 |
| Comparative Example 2 | Vinyltriethoxy silane | 1.397 |
| Comparative Example 3 | Triallyl isocyanurate | 1.511 |
| | (TAIC) | |

According to Table 1, it can be confirmed that the compound of Chemical Formula 1 has a lower refractive index by simultaneously including a silane group, a vinyl group, and a perfluoroalkyl group in one molecule than Comparative Examples which do not simultaneously include the silane group, the vinyl group, and the perfluoroalkyl group.

In particular, it can be confirmed that when Examples 1 to 6 are compared with Comparative Examples 1 to 3, the compound of Chemical Formula 1 has a low refractive index by including a perfluoroalkyl group.

1. A compound of the following Chemical Formula 1: 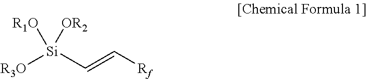
wherein, in the Chemical Formula 1,
R₁ to R₃ are each independently an alkyl group,
R_{f} is CₙF₂ₙ₊₁, and n is an integer from 1 to 20.

2. The compound of claim 1, wherein R₁ to R₃ are each independently an alkyl group having 1 to 10 carbon atoms.

3. The compound of claim 1, wherein n is an integer from 3 to 20.

4. The compound of claim 1, wherein the compound of Chemical Formula 1 is any one selected from the following compounds:

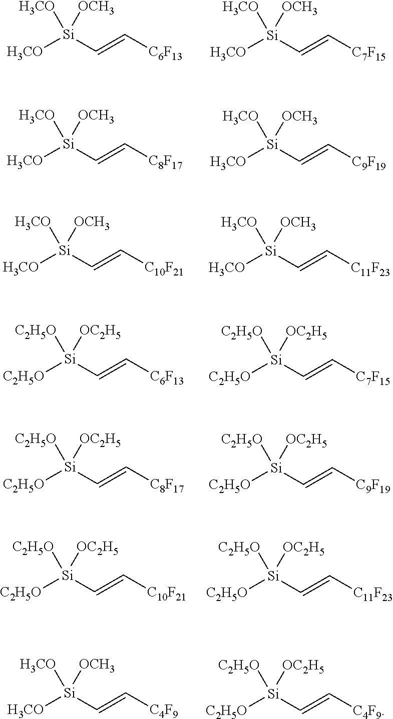

5. The compound of claim 1, wherein the compound has a refractive index of 1.45 or less.

6. A coating composition comprising the compound of claim 1.

7. The coating composition of claim 6, further comprising one or more curable compounds.

8. The coating composition of claim 6, wherein the coating composition has a refractive index of 1.5 or less.

9. A method for preparing the compound according to claim 1, the method comprising: synthesizing an alkoxy silane intermediate by mixing an alkoxy silane compound and a perfluoroalkyl compound; and
introducing a double bond into the alkoxy silane intermediate through an elimination reaction to prepare the compound.

10. The method of claim 9, wherein the alkoxy silane compound is represented by the following Chemical Formula 2: 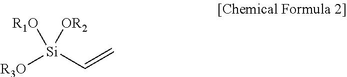
in the Chemical Formula 2,
R₁ to R₃ are each independently an alkyl group.

11. The method of claim 9, wherein the perfluoroalkyl compound is represented by the following Chemical Formula 3:
X—R_{f} [Chemical Formula 3]
in the Chemical Formula 3,
X is a halogen group,
R_{f} is CₙF₂ₙ₊₁, and n is an integer from 1 to 20.

12. The method of claim 9, wherein in the synthesizing of the alkoxy silane intermediate, a radical chain reaction is performed.

13. The method of claim 9, wherein the compound has a lower refractive index than the alkoxy silane compound.

14. An electronic device comprising the compound of claim 1 or a cured product thereof.
